(19) United States
(12) Patent Application Publication
(10) Pub. No.: US 2007/0053368 A1
(43) Pub. Date: Mar. 8, 2007

(54) Graphical representations of aggregation groups

(76) Inventors: Darda Chang, Austin, TX (US); Michael Sean McGee, Round Rock, TX (US); Matthew S. Reeves, Round Rock, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/222,306

(22) Filed: Sep. 8, 2005

(51) Int. Cl. H04L 12/28

(52) U.S. Cl. 370/401

(57) ABSTRACT

The apparatus in one example may have: aggregation groups of network ports; a respective aggregation group having a formation that is one of statically formed, dynamically formed, unknown, or empty; a respective aggregation group having a state that is one of a working state, a degraded state or a failed state; and graphical representation of the formations and states of the aggregation groups, the graphical representation depicting a current status of the aggregation groups of network ports.

### BACKGROUND

Computers and other devices may be networked together using any one of several available architectures and any one of several corresponding and compatible network protocols. In an one known architecture, the computers each include a bus system with corresponding slots for receiving compatible network adapter expansion cards, where one or more of the adapter cards may be network interface cards (NICs). Each NIC includes an appropriate connector for interfacing a compatible network cable, such as a coaxial cable, a twisted-wire cable, a fiber optic cable, etc.

In a packet-switched configuration, each computer or device sends data packets according to a selected upper level protocol, such as Transmission Control Protocol/Internet Protocol (TCP/IP), the Internet Protocol eXchange (IPX), NetBEUI or the like. NetBEUI is short for NetBIOS Enhanced User Interface, and is an enhanced version of the NetBIOS protocol used by network operating systems such as LAN Manager, LAN Server, Windows for Workgroups, Windows 95 and Windows NT. NetBEUI was originally designed for use with a LAN Manager server and later extended. TCP/IP is used in Internet applications, or in intranet applications such as a local area network (LAN). In this manner, computers and other devices share information according to the higher level protocols.

A known port-centric controller system for a computer includes a plurality of network ports implemented with a plurality of network controllers and a driver system capable of operating each of the network ports in either a stand-alone mode or a team mode where each team includes at least two network ports. The driver system monitors the status of each of the network ports. The controller system further includes configuration logic that interfaces the driver system to display port-specific graphic representations of the configuration and status of each of the plurality of network ports. The graphic representations preferably distinguish between each of the plurality of network controllers and each of the plurality of network ports.

Link Aggregation allows one or more links to be aggregated together to form a Link Aggregation Group, such that a MAC (Media Access Control) Client can treat the Link Aggregation Group as if it were a single link. The current teaming solution described above does not represent any aggregation concept even though it supports aggregation statically on Switch-assistant Load-Balancing (SLB) team type and dynamically on Automatic and 802.3ad Dynamic with Fault Tolerance team types.

An aggregation group is a logical grouping for team members to form a trunk, channel, or link aggregation. A team consists of one or more aggregation groups. An aggregation group consists of one or more team members. All team members in an aggregation group transmit frames with a source-address equal to an aggregation group's transmit address.

### SUMMARY

In one implementation an apparatus comprises: aggregation groups of network ports; a respective aggregation group having a formation that is one of statically formed, dynamically formed, unknown, and empty; a respective aggregation group having a state that is one of a working state, a degraded state and a failed state; and graphical representations of the formations and states of the aggregation groups, the graphical representations depicting a current status of the aggregation groups of network ports.

### DESCRIPTION OF THE DRAWINGS

Features of exemplary implementations of the present method and apparatus will become apparent from the description, the claims, and the accompanying drawings in which:

FIG. 1 is a block diagram of an exemplary computer system used in conjunction with the present method and apparatus.

FIG. 2 is a block diagram of the computer system of FIG. 1 coupled to a network.

FIG. 3 is a block diagram of a controller system installed on the computer system of FIG. 1 and implemented according to an embodiment of the present apparatus and method.

FIG. 4 is a depiction of a graphical user interface for displaying the current aggregation groups of network ports.

FIG. 5 is a representation of one exemplary process flow for depicting aggregation of network ports.

FIG. 6 is a representation of one exemplary process flow for depicting aggregation of network ports.

FIG. 7 is a representation of another exemplary process flow for depicting aggregation of network ports.

### DETAILED DESCRIPTION

A common computer network implementation includes a plurality of clients, such as personal computers or work stations, connected to each other and one or more servers via a switch or router by network cable. The network may be configured to operate at one or more data transmission rates, typically 10 Mbit/sec (e.g., 10 Base-T Ethernet), 100 Mbit/sec (e.g., 100 Base-T Fast Ethernet), or 1 Gigabit/sec. Data may be forwarded on the network in packets which are typically received by a switch from a source network device and then directed to the appropriate destination device. The receipt and transmission of data packets by a switch occurs via ports on the switch. Packets traveling from the same source to the same destination are defined as members of the same stream.

Since network switches typically receive data from and transmit data to several network devices, and the cable connections between the various network devices typically transmit data at the same rate, a bottle-neck may be created when, for example, several devices (e.g., clients) are simultaneously attempting to send data to a single other device (e.g., a server). In this situation, the data packets must sit in a queue at the port for the server and wait for their turn to be forwarded from the switch to the server.

One way to relieve this bottle-neck is to provide a logical grouping of multiple ports into a single port. The bandwidth of the new port is increased since it has multiple lines (cables) connecting a switch and another network device, each line capable of carrying data at the same rate as the line connecting data sources to the switch. This grouping of ports is sometimes referred to as a port aggregation or port group.

In order for networking equipment to make optimal utilization of the increased bandwidth provided by a port group, packet transmissions must be distributed as evenly as possible across the ports of the group. In addition, a suitable distribution system will ensure that packets in the same stream are not forwarded out of order.

Traffic distribution for ports grouped in port groups has conventionally been accomplished by static distribution of addresses across the ports of a group. In one example of such a static distribution of network traffic, as a packet of data to be forwarded is received by a switch, its destination address is determined, and it is assigned to the port group connecting with its destination. Assignment to a port within the port group may be done in a number of ways. For example, each packet assigned to the port group may be assigned to the next port in a cycle through the ports, or the assignment may be based on the packet's source address. However it is done, this assignment is permanent, so that if a second packet with the same address is subsequently received by the switch, it is assigned to the same port assigned to the previous packet with that address. The one exception to this permanent assignment in conventional systems may be the removal of an address due to aging, that is, if a long enough period of time (e.g., 10 to 1,000,000 seconds, typically 300 seconds) passes between the receipt of two packets of data having the same address, the second packet may be assigned to a different port. Another static address distribution system performs a simple logical operation on a packet's source and destination addresses (exclusive OR of the two least significant bits of the addresses) in order to identify the port within a group to be used to transmit a packet.

Static address distribution systems ensure that packets from a given stream are not forwarded out of order by permanently assigning the stream to a particular port. In this way, packets in a stream can never be forwarded to their destination by the switch out of order. For example, an earlier packet in the stream may not be forwarded by the switch before a later one via a different less-busy port in the group since all packets from that stream will always be forwarded on the same port in the group.

There are known systems that meet this need by providing methods, apparatuses and systems for balancing the load of data transmissions through a port aggregation. Such systems allocate port assignments based on load, that is, the amount of data being forwarded through each port in the group. The load balancing is preferably dynamic, that is, packets from a given stream may be forwarded on different ports depending upon each port's current utilization. When a new port is selected to transmit a particular packet stream, it is done so that the packets cannot be forwarded out of order. This is preferably accomplished by ensuring passage of a period of time sufficient to allow all packets of a given stream to be forwarded by a port before a different port is allocated to transmit packets of the same stream.

Several different graphic icons may be used to illustrate the status and configuration information of network ports. The driver system may monitor the link status of each of the network ports indicative of cable status, and the graphic representations may include a corresponding cable fault icon indicative of a cable fault at a network port. The graphic representations may include separate icons for a powered off status, a hardware failure status and the cable fault status. The graphic representations may further include an icon representing a powered off due to the cable fault status, an icon representing a hardware failure when powered off status and an icon representing detection of an uninstalled network controller. The graphic representations may further include an icon representing each network port in a team of network ports and an icon representing a non-active network port in the team. The graphic representations may further include team, controller, slot and bus information.

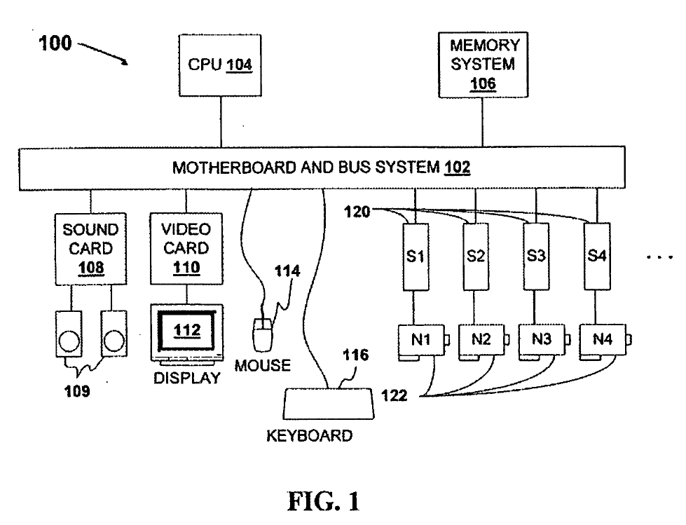

Turning to FIG. 1, an apparatus 100 in one example depicts an exemplary computer system 100 that is used to illustrate various aspects of a network system. The computer system 100 may preferably be, for example, an industry standard server compatible with processors made by Intel (alternatively, it may be a personal computer (PC) system or the like), and may include a motherboard and bus system 102 coupled to at least one central processing unit (CPU) 104, a memory system 106, a video card 110 or the like, a mouse 114 and a keyboard 116. The motherboard and bus system 102 may include any kind of bus system configuration, such as any combination of a host bus, one or more peripheral component interconnect (PCI) buses, an industry standard architecture (ISA) bus, an extended ISA (EISA) bus, microchannel architecture (MCA) bus, PCI-X, PCI-e, etc., along with corresponding bus driver circuitry and bridge interfaces, etc., as known to those skilled in the art. The CPU 104 preferably incorporates any one of several microprocessors and supporting external circuitry. The external circuitry preferably includes an external or level two (L2) cache or the like (not shown). The memory system 106 may include a memory controller or the like and be implemented with one or more memory boards (not shown) plugged into compatible memory slots on the motherboard, although any memory configuration is contemplated.

Other components, devices and circuitry are normally included in the computer system 100 are not particularly relevant to the present method and apparatus and are not shown. Such other components, devices and circuitry are coupled to the motherboard and bus system 102, such as, for example, an integrated system peripheral (ISP), an interrupt controller such as an advanced programmable interrupt controller (APIC) or the like, bus arbiter(s), one or more system ROMs (read only memory) comprising one or more ROM modules, a keyboard controller, a real time clock (RTC) and timers, communication ports, non-volatile static random access memory (NVSRAM), a direct memory access (DMA) system, diagnostics ports, command/status registers, battery-backed CMOS memory, etc. Although the present method and apparatus are illustrated with the FIG. 1 computer system, it is understood that other types of computer systems and processors may be utilized.

The computer system 100 may also include one or more output devices, such as speakers 109 coupled to the motherboard and bus system 102 via an appropriate sound card, and a monitor or display 112 coupled to the motherboard and bus system 102 via an appropriate video card 110. One or more input devices may also be provided such as a mouse 114 and keyboard 116, each coupled to the motherboard and bus system 102 via appropriate controllers (not shown) as known to those skilled in the art. Other input and output devices may also be included, such as one or more disk drives including floppy and hard disk drives, one or more CD-ROMs, as well as other types of input devices including a microphone, joystick, pointing device, etc. The input and output devices enable interaction with a user of the computer system 100 for purposes of configuration, as further described below.

The motherboard and bus system 102 is preferably implemented with one or more expansion slots 120, individually labeled S1, S2, S3, S4 and so on, where each of the slots 120 is configured to receive compatible adapter or controller cards configured for the particular slot and bus type. Typical devices configured as adapter cards include network interface cards (NICs), disk controllers such as a SCSI (Small Computer System Interface) disk controllers, video controllers, sound cards, etc. The computer system 100 may include one or more of several different types of buses and slots, such as PCI, ISA, EISA, MCA, etc. In the embodiment shown, a plurality of NIC adapter cards 122, individually labeled N1, N2, N3 and N4, are shown coupled to the respective slots S1-S4. The slots 120 and the NICs 122 are preferably implemented according to PCI, although any particular bus standard is contemplated.

As described more fully below, each of the NICs 122 enables the computer system to communicate with other devices on a corresponding network. The computer system 100 may be coupled to at least as many networks as there are NICs 122, or two or more of the NICs 122 may be coupled to the same network via a common network device, such as a hub or a switch. When multiple NICs 122 are coupled to the same network, each provides a separate and redundant link to that same network for purposes of fault tolerance or load balancing, otherwise referred to as load sharing. Each of the NICs 122, or N1-N4, may communicate using packets. As known to those skilled in the art, a destination and source address is commonly included near the beginning of each packet, where each address is at least 48 bits for a corresponding media access control (MAC) address. A directed or unicast packet includes a specific destination address rather than a multicast or broadcast destination. A broadcast bit is set for broadcast packets, where the destination address are all ones (1's). A multicast bit in the destination address is set for multicast packets.

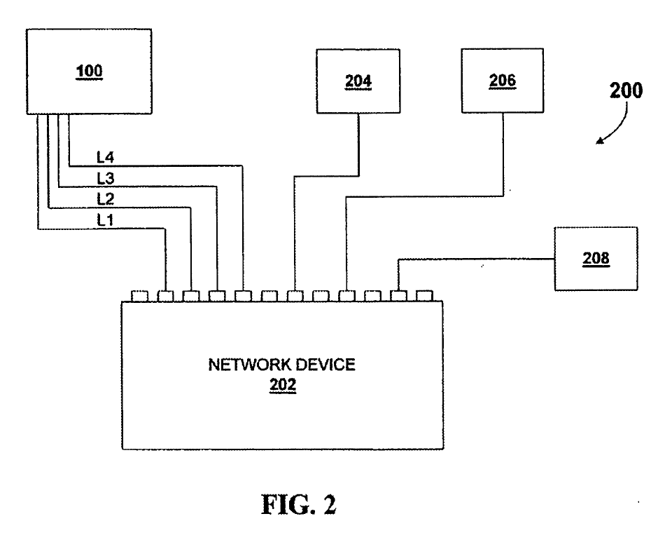

Referring now to FIG. 2, a block diagram is shown of a network 200 that enables the computer system 100 to communicate with one or more other devices, such as devices 204, 206 and 208 as shown. The devices 204, 206 and 208 may be of any type, such as another computer system, a printer or other peripheral device, or any type of network device, such as a hub, a repeater, a router, etc. The computer system 100 and the devices 204-208 are communicatively coupled together through a multiple port network device 202, such as a hub or switch, where each is coupled to one or more respective ports of the network device 202. The network 200, including the network device 202, the computer system 100 and each of the devices 204-208, may operate according to any network architecture. The network 200 may have the form of any type of Local Area Network (LAN) or Wide Area Network (WAN), and may comprise an intranet and be connected to the Internet. For example, the device 208 may comprise a router that connects to an Internet provider.

The computer system 100 is coupled to the network device 202 via a plurality of links L1, L2, L3 and L4. The NICs N1-N4 each comprise a single port to provide a respective link L1-L4. It is noted that the computer system 100 may be coupled to the network device 202 via any number of links from one to a maximum number, such as sixteen (16). Also, any of the NICs may have any number of ports and is not limited to one.

The use of multiple links to a single device, such as the computer system 100, provides many benefits, such as fault tolerance or load balancing. In fault tolerance mode, one of the links, such as the link L1 and the corresponding NIC N1 is active while one or more of the remaining NICs and links are in standby mode. If the active link fails or is disabled for any reason, the computer system 100 switches to another NIC and corresponding link, such as the NIC N2 and the link L2, to continue or maintain communications. Although two links may provide sufficient fault tolerance, three or more links provides even further fault tolerance in the event two or more links become disabled or fail. For load balancing, the computer system 100 may distribute data among the redundant links according to any desired criterion to increase data throughput.

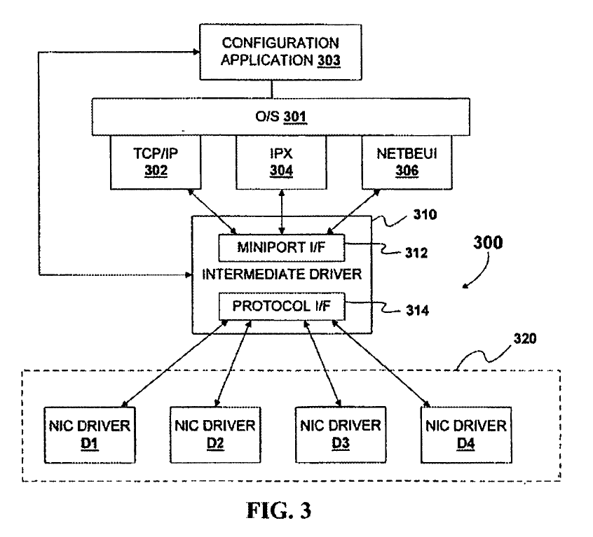

FIG. 3 is a block diagram of a controller system 300 installed on the computer system 100 and implemented according to the present method and apparatus to enable teaming of any number of NIC ports to act like a single virtual or logical device. As shown in FIG. 3, four NIC drivers D1-D4 are installed on the computer system 100, each for supporting and enabling communications with a respective port of one of the NICs N1-N4. The computer system 100 is installed with an appropriate operating system (O/S) 301 that supports networking. The O/S 301 includes, supports or is otherwise loaded with the appropriate software and code to support one or more communication protocols, such as TCP/IP 302, IPX (Internet Protocol eXchange) 304, NetBEUI (NETwork BIOS End User Interface) 306, etc. Normally, each protocol binds with one NIC driver to establish a communication link between a computer and the network supported by the bound NIC. In general, binding a NIC port associates a particular communication protocol with the NIC driver and enables an exchange of their entry points. Instead, in the controller system 300, an intermediate driver 310 is installed as a stand alone protocol service that operates to group two or more of the NIC drivers D1-D4 so that the corresponding two or more ports function as one logical device.

In particular, each of the protocols 302-306 bind to a miniport interface (I/F) 312, and each of the NIC drivers D1-D4 bind to a protocol I/F 314, of the intermediate driver 310. In this manner, the intermediate driver 310 appears as a NIC driver to each of the protocols 302-306. Also, the intermediate driver 310 appears as a single protocol to each of the NIC drivers D1-D4 and corresponding NICs N1-N4. The NIC drivers D1-D4 (and the NICs N1-N4) are bound as a single team 320 as shown in FIG. 3. It is noted that a plurality of intermediate drivers may be included on the computer system 100, where each binds two or more NIC drivers into a team. Thus, the computer system 100 may support multiple teams of any combination of ports of installed NICs and NIC drivers. By binding two or more ports of physical NICs to the protocol I/F of the intermediate driver, data can be routed through one port or the other, with the protocols interacting with only one logical device.

Port representations rather than NIC representations provide a more accurate depiction of the controller and port configurations. In an embodiment an intermediate driver of each team may monitor the status of each port in its team and may report the status of each port to a configuration application. Also, the configuration application may retrieve status information from respective drivers of ports operating independently or stand-alone. The configuration application may display the status of each port in graphical form. The status of each port may preferably be updated continuously or periodically, such as after every timeout of a predetermined time period. The configuration application correspondingly updates the displayed graphic representations of port status.

While the network industry tries to ease the management configuration and efficiently manage the physical link ports by introducing the channel, trunk, or aggregation statically or dynamically, the creation of channel, trunk, or aggregation statically is quite error-prone. Until the embodiments of the present method and apparatus, there were no solutions for graphical representation of the progress of forming aggregation dynamically.

In general terms embodiments of the present method and apparatus involve a graphical representation having a first graphic depiction of formations of aggregation groups of network ports, and a second graphic depiction of states of the aggregation groups, the graphical representation depicting current statuses of the aggregation groups of network ports as the aggregation groups are formed.

In a network, such as depicted in FIG. 2, the aggregation groups of network ports may be classified according to four types: Static, Dynamic, Unknown, and Empty. “Static” refers to manual group formation. “Dynamic” refers to using dynamic protocols such as Link Aggregation Control Protocol (LACP) to form a group. “Unknown” refers to a situation where there is a failure to form a group with dynamic protocols such as LACP, and an unknown group is formed. “Empty” is used as a place holder to indicate that all the ports within the aggregation group are disabled or un-installed. The group “Empty” may be a special case for applications to handle.

For each existing aggregation group, there may be three states: a “Working” state where all ports in the aggregation group are working properly, a “Degraded” state where at least one, but not all ports in the aggregation group is degraded or has failed, and a “Failed” state where all ports in the aggregation group have failed.

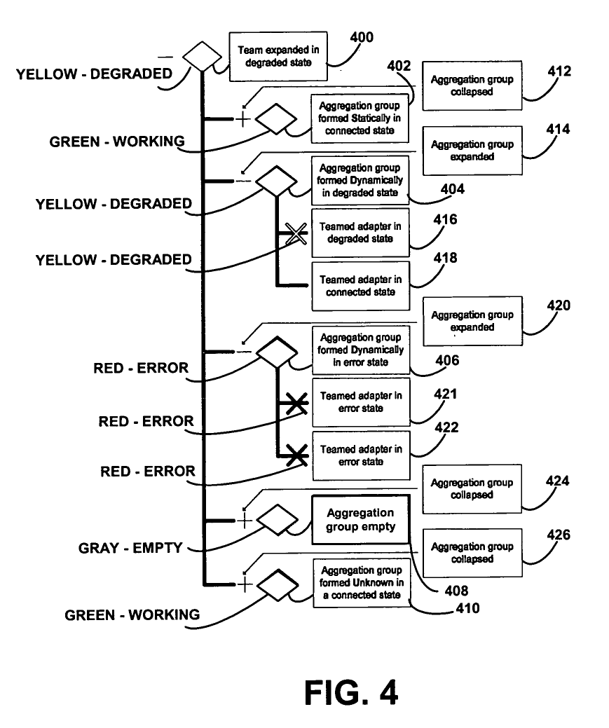

Different colors, icons, or bitmaps may be used to represent the types and states of the aggregation groups. FIG. 4 depicts one example of the use of colors, icons and bitmaps.

FIG. 4 is a depiction of a graphical user interface for displaying the current aggregation groups of network ports. In this example, the expanded team 400 of network ports in shown as a diamond having a first color, for example yellow (because some of the aggregation groups are degraded). The team 400 is formed by aggregation groups 402, 404, 406, 408, and 410. The aggregation group 402 is depicted in a collapsed state, and may be expanded via a software button 412. The aggregation group 402 has been formed statically and is in a working (or connected) state (green).

It is to be understood that the graphical user interface may be viewed by a user on a display that is operatively coupled to, or is part of, one of a plurality of interconnected servers. Alternatively, the graphical user interface may be on a display system that is separate from (but operatively coupled to) the plurality of interconnected servers.

The aggregation group 404 is depicted in an expanded state, and may be collapsed via a software button 414. The aggregation group 404 is formed dynamically and is in a degraded state (yellow). The aggregation group 404 is in a degraded state because a member (network port) 416 is in a degraded state, while a member (network port) 418 is in a working state.

The aggregation group 406 is depicted in an expanded state, and may be collapsed via a software button 420. The aggregation group 406 is formed dynamically and is in an error state (red). The aggregation group 406 is in an error state because each member (network port) 421, 422 is in an error state.

The aggregation group 408 is depicted in a collapsed state, and may be expanded via a software button 424. The aggregation group 402 is empty that is all ports within the aggregation group may be disabled or un-installed.

The aggregation group 410 is depicted in a collapsed state, and may be expanded via a software button 426. The aggregation group 410 is in a working state (green).

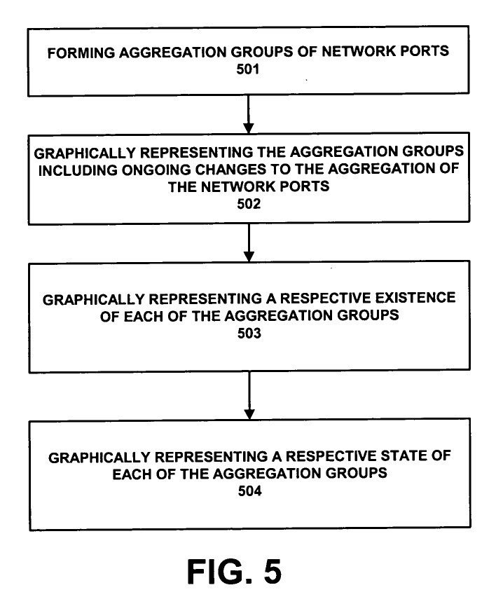

FIG. 5 is a representation of one exemplary process flow for depicting aggregation of network ports. This embodiment may have the steps of: forming aggregation groups of network ports (501); graphically representing the aggregation groups (502); graphically representing a respective existence of each of the aggregation groups (503); and graphically representing a respective state of each of the aggregation groups (504).

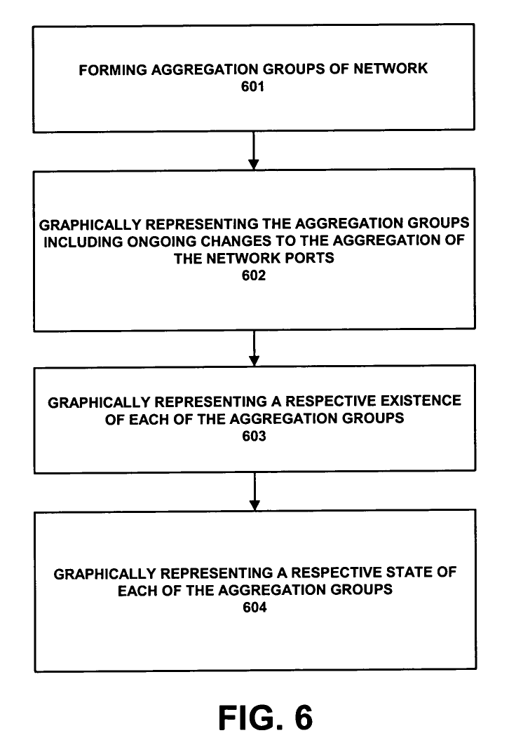

FIG. 6 is a representation of one exemplary process flow for depicting aggregation of network ports. This embodiment may have the steps of: forming aggregation groups of network (601); graphically representing the aggregation groups including ongoing changes to the aggregation of the network ports (602); graphically representing a respective existence of each of the aggregation groups (603); and graphically representing a respective state of each of the aggregation groups (604). Thus, the aggregation groups may be graphically represented in substantially real time as the aggregation groups are formed.

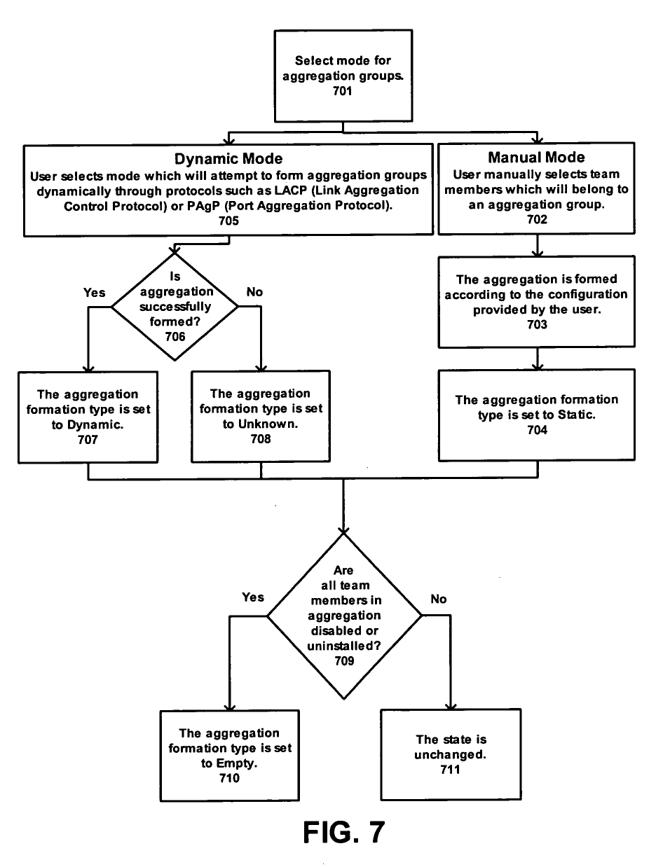

FIG. 7 is a representation of another exemplary process flow for depicting aggregation of network ports. This embodiment may have the steps of: Select mode for aggregation groups. (701); in a manual mode a user manually selects team members which will belong to an aggregation group. (702); in the manual mode the aggregation is formed according to the configuration provided by the user. (703); in the manual mode the aggregation formation type is then set to Static. (704); in a dynamic mode a user selects mode which will attempt to form aggregation groups dynamically through protocols such as LACP (Link Aggregation Control Protocol) or PAgP (Port Aggregation Protocol). (705); in the dynamic mode it is then determined if the aggregation is successfully formed. (706); in the dynamic mode, when the aggregation is successfully formed, the aggregation formation type is set to Dynamic. (707); in the dynamic mode, when the aggregation is not successfully formed, the aggregation formation type is set to Unknown. (708); after either of the static or dynamic mode, it is determined if all team members in the aggregation are disabled or uninstalled. (709); if all team members in the aggregation are disabled or uninstalled, then the aggregation formation type is set to Empty. (710); and if all team members in the aggregation are not disabled or uninstalled, then the state is unchanged. (711).

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

What is claimed is:

1. An apparatus comprising:
aggregation groups of network ports;
a respective aggregation group having a formation that is one of statically formed, dynamically formed, unknown, or empty;
a respective aggregation group having a state that is one of a working state, a degraded state or a failed state; and
graphical representations of the formations and states of the aggregation groups, the graphical representations depicting current status of the aggregation groups of network ports.

2. The apparatus according to claim 1, wherein the aggregation groups are grouped into a higher level aggregation group.

3. The apparatus according to claim 1, wherein the apparatus further comprises a depiction of an aggregation group being in one of a working state, a degraded state or a failed state by use of a differentiation scheme.

4. The apparatus according to claim 3, wherein the differentiation scheme is a color coding scheme.

5. A method comprising:
forming aggregation groups of network ports;
graphically representing the aggregation groups;
graphically representing a respective formation of each of the aggregation groups; and
graphically representing a respective state of each of the aggregation groups, the graphical representations depicting current status of the aggregation groups of network ports.

6. The method according to claim 5, wherein each aggregation group is identified as one of being formed statically, being formed dynamically, being unknown, or being empty.

7. The method according to claim 6, wherein the method further comprises grouping the aggregation groups into a higher level aggregation group.

8. The method according to claim 5, wherein a respective state is one of a working state, a degraded state or a failed state.

9. The method according to claim 8, wherein the method further comprises depicting that an aggregation group is in one of a working state, a degraded state or a failed state by use of a differentiation scheme.

10. The method according to claim 9, wherein the differentiation scheme is a color coding scheme.

11. The method according to claim 5, wherein the method further comprises graphically representing the aggregation groups as the aggregation groups are formed.

12. The method according to claim 5, wherein the method further comprises graphically representing ongoing changes to the aggregation groups of network ports.

13. A method comprising:
forming aggregation groups of network ports;
graphically representing the aggregation groups including ongoing changes to the aggregation of the network ports;
graphically representing a respective formation of each of the aggregation groups; and
graphically representing a respective state of each of the aggregation groups, the graphical representations depicting current status of the aggregation groups of network ports.

14. The method according to claim 13, wherein the method further comprises grouping the aggregation groups into a higher level aggregation group.

15. The method according to claim 13, wherein each aggregation group is identified as one of being formed statically, being formed dynamically, being unknown, or being empty.

16. The method according to claim 15, wherein the respective state is one of a working state, a degraded state or a failed state.

17. The method according to claim 16, wherein the method further comprises depicting that an aggregation group is in one of a working state, a degraded state or a failed state by use of a differentiation scheme.

18. The method according to claim 17, wherein the differentiation scheme is a color coding scheme.

19. The method according to claim 16, wherein being formed statically refers to manual group formation, being formed dynamically refers to using dynamic protocols to form a group, being unknown refers to a situation where there is a failure to form a group with dynamic protocols, or being empty is used as a place holder to indicate that all ports within a respective aggregation group are disabled or un-installed, and wherein a working state refers to all ports in a respective aggregation group working properly, a degraded state refers to a state where at least one, but not all ports in a respective aggregation group is degraded or has failed, and a failed state refers to a state where all ports in a respective aggregation group have failed.

20. The method according to claim 13, wherein the method further comprises graphically representing the aggregation groups as the aggregation groups are formed.

21. An apparatus comprising:
a graphical representation having a first graphic depiction of formations of aggregation groups of network ports, and a second graphic depiction of states of the aggregation groups, the graphical representation depicting current statuses of the aggregation groups of network ports as the aggregation groups are formed.

22. The apparatus according to claim 21, wherein the apparatus further comprises a depiction of an aggregation group being in one of a working state, a degraded state or a failed state by use of a differentiation scheme.

23. The apparatus according to claim 22, wherein the differentiation scheme is a color coding scheme.

24. The apparatus according to claim 21, wherein a respective formation of a respective aggregation group of the aggregation groups of network ports is one of statically formed, dynamically formed, unknown, or empty.

25. The apparatus according to claim 21, wherein a respective state of a respective aggregation group of the aggregation groups of network ports is one of a working state, a degraded state or a failed state.
